(19) United States
(12) Patent Application Publication
(10) Pub. No.: US 2011/0037398 A1
(43) Pub. Date: Feb. 17, 2011

(54) Circuit Arrangement and Method for Starting a Discharge Lamp

(75) Inventor: Joachim MUEHLSCHLEGEL, Groebenzell (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Gesellschaft mit beschrankter Haftung, Munich (DE)

(21) Appl. No.: 12/836,431

(22) Filed: Jul. 14, 2010

(30) Foreign Application Priority Data
Jul. 14, 2009 (DE) 10 2009 032 985.4

(51) Int. Cl. H05B 41/36

(52) U.S. Cl. 315/209 R

(57) ABSTRACT

A circuit arrangement for starting a discharge lamp, with a primary circuit, which comprises a series circuit comprising an inductance (L), a starting capacitor (C1) and a first switch (SG), the switch being in the form of a threshold value switch, and the inductance comprising the primary winding (L1) of the starting transformer (TR), and the primary circuit being designed to generate a starting pulse for the discharge lamp at the secondary winding (L2) of a starting transformer (TR), the primary circuit having two decoupled voltages, a first voltage, which is correlated substantially with the energy of the starting pulse, and a second voltage, which controls the operating time of the switch, the first voltage being lower than the threshold value of the first switch. Also disclosed is a method for starting a discharge lamp, with a primary circuit which generates a starting pulse for the discharge lamp at the secondary winding of a starting transformer, the primary circuit comprising a series circuit comprising an inductance, a starting capacitor and a first switch, which is in the form of a threshold value switch, characterized by the following steps: charging the starting capacitor to a first voltage, and applying a second voltage to the first switch in order to switch on said switch.

### RELATED APPLICATIONS

This application claims the priority of German patent application no. 10 2009 032 985.4 filed Jul. 14, 2009.

### FIELD OF THE INVENTION

The invention relates to a circuit arrangement for starting a discharge lamp, with a primary circuit, which comprises a series circuit comprising an inductance, a starting capacitor and a first switch, the switch being in the form of a threshold value switch, and the inductance comprising the primary winding of the starting transformer, and the primary circuit being designed to generate a starting pulse for the discharge lamp at the secondary winding of a starting transformer.

### BACKGROUND OF THE INVENTION

The invention is based on a circuit arrangement for starting a discharge lamp in accordance with the generic type of the main claim.

FIG. 1 shows a circuit arrangement for starting a discharge lamp in accordance with the prior art, in which a high circuit current through a primary winding L1 of a starting transformer TR is generated in the primary circuit and is stepped up to a high secondary-side starting voltage U3. This starting voltage U3 is applied to the gas discharge lamp. The primary circuit in this case comprises a series circuit comprising the primary winding L1 of the starting transformer TR, a starting capacitor C1 and a first switch in the form of a spark gap SG. In the operating mode which is conventional in the prior art, in which the starting capacitor C1 is charged slowly until the voltage U1 applied thereto is sufficiently high for it to be possible for the spark gap to break down, the voltage at the spark gap SG is substantially equal to the voltage at the starting capacitor C1 since the inductance of the primary winding of the starting transformer TR is transmissive for DC voltage. The starting capacitor C1 is in this case charged via a voltage source U11, R11 until its voltage has reached the breakdown voltage of the spark gap and said spark gap breaks down. In this case, the voltage U2 at the spark gap SG is reduced in a very short period of time to very low values, which results in a very high current through the primary winding L1 and the spark gap SG. In the process, the charge of the starting capacitor C1 is largely discharged. As a result of the high primary-side current, a starting pulse is produced on the secondary side of the starting transformer TR and is applied to the gas discharge lamp. The current and therefore the level of the starting pulse is in this case dependent on the charging voltage U1 at the time of the breakdown of the spark gap SG. A voltage U1 is therefore applied to the primary circuit, said voltage U1 ensuring that the starting capacitor C1 is charged and the spark gap SG is switched on. However, spark gaps have the disadvantage that the breakdown voltage is severely subject to tolerances, and the starting energy found in the primary circuit as a result of the charging of the starting capacitor C1 thus likewise fluctuates to a considerable extent. This makes the process of starting the gas discharge lamp a statistical process, which is very undesirable.

In a further prior art, a controllable semiconductor switch, for example a thyristor or a MOSFET is used instead of the spark gap. However, semiconductor switches have the disadvantage of a high internal resistance in comparison with the spark gap, which results in a significantly lower primary current and therefore also in a significantly lower starting pulse.

### SUMMARY OF THE INVENTION

One object of the invention is to provide a circuit arrangement for starting a discharge lamp, with a primary circuit, which comprises a series circuit comprising an inductance, a starting capacitor and a first switch, the switch being in the form of a threshold value switch, and the inductance comprising the primary winding of the starting transformer, and the primary circuit being designed to generate a starting pulse for the discharge lamp at the secondary winding of a starting transformer, by means of which the starting energy can be predefined deterministically.

This and other objects are attained in accordance with one aspect of the invention directed to a circuit arrangement for starting a discharge lamp, with a primary circuit, which comprises a series circuit comprising an inductance, a starting capacitor and a first switch, the switch being in the form of a threshold value switch, and the inductance comprising the primary winding of the starting transformer, and the primary circuit being designed to generate a starting pulse for the discharge lamp at the secondary winding of a starting transformer, the primary circuit having two decoupled voltages, a first voltage, which is correlated substantially with the energy of the starting pulse, and a second voltage, which controls the operating time of the switch, the first voltage being lower than the threshold value of the first switch. By virtue of this measure, the starting time of the discharge lamp can be decoupled from the starting energy, and the starting energy can be set to a predefined value. By virtue of the fact that the first switch is in the form of a threshold value switch, said switch is switched on when the second voltage corresponds to its threshold value.

Depending on the profile of requirements, the voltages can be decoupled by a diode or an inductance. Decoupling by means of an inductance is suitable in particular when using a rapid-response first switch, whereas decoupling by means of a diode has a broader application area.

The fact that the switch is in the form of a threshold value switch opens up the possibility of using a large number of possible physical switches; for example the first switch can be a spark gap or a SIDAC or a component with a similar threshold value characteristic. A spark gap as the threshold value switch provides the advantage of a very low internal resistance and the high starting efficiency associated therewith. The threshold value switch in this case preferably has a parallel capacitance, via which a voltage across the threshold value switch can be built up by means of a transfer of charge to the capacitance. Preferably, a controllable voltage source or a controllable current source or a DC/DC voltage converter or a charge pump is used for charging the parallel capacitance. Particularly preferably, a DC/DC voltage converter which is in the form of an inductor-type step-up converter which a second switch is used for charging the parallel capacitance.

The inductor-type step-up converter is preferably designed such that a zener diode is arranged in series with the second switch. By virtue of this measure, the off-state voltage of the transistor can be smaller, and the inductor-type converter can have a less expensive design.

Another aspect of the invention is directed to a method for starting a discharge lamp, with a primary circuit which comprises a series circuit comprising an inductance, a starting capacitor and a first switch, the switch being in the form of a threshold value switch and the inductance comprising the primary winding of the starting transformer, and the primary circuit being designed to generate a starting pulse for the discharge lamp at the secondary winding of a starting transformer, characterized by the following steps:

charging the starting capacitor to a first voltage, and

applying a second voltage to the first switch in order to switch on said switch.

By virtue of this measure, the starting time of the discharge lamp can be decoupled from the starting energy, and the starting energy can be set to a predefined value.

### BRIEF DESCRIPTION OF THE DRAWINGS

Further advantages, features and details of the invention can be gleaned from the description below relating to exemplary embodiments and from the drawings, in which identical or functionally identical elements have been provided with identical reference symbols and in which:

FIG. 1 shows a circuit arrangement for starting a discharge lamp in accordance with the prior art.

FIG. 2 shows a circuit arrangement according to a first embodiment of the invention for starting a discharge lamp with a diode as decoupling element.

FIG. 3 shows a circuit arrangement according to a second embodiment of the invention for starting a discharge lamp with a diode as decoupling element, which is part of an inductor-type step-up converter which uses the primary winding of the starting transformer as inductor.

FIG. 4 shows a circuit arrangement according to a third embodiment of the invention for starting a discharge lamp with a diode as decoupling element and an inductor-type step-up converter.

FIG. 5 shows a circuit arrangement according to a fourth embodiment of the invention for starting a discharge lamp with the primary winding of the starting transformer as decoupling element and a spark gap for increasing the second voltage.

FIG. 6 shows some relevant signals which illustrate the mode of operation of the circuit arrangement according to an embodiment of the invention at a charging voltage of the starting capacitor of 500V.

FIG. 7 shows some relevant signals which illustrate the mode of operation of the circuit arrangement according to an embodiment of the invention at a charging voltage of the starting capacitor of 700V.

### DETAILED DESCRIPTION OF THE DRAWINGS

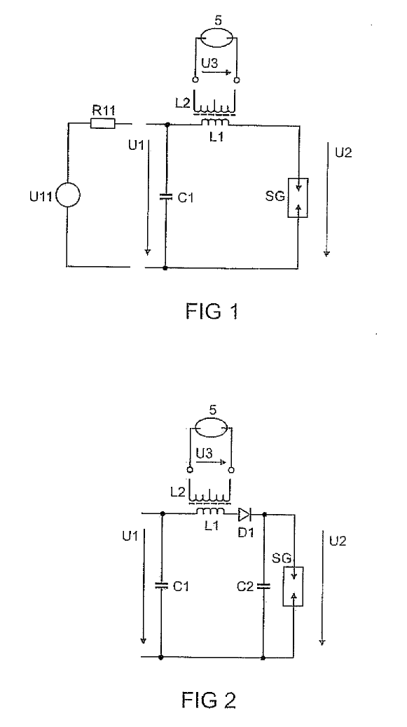

FIG. 2 shows a circuit arrangement according to the invention for starting a discharge lamp in a first embodiment with a diode D1 as decoupling element and a spark gap SG as a first switch. The diode D1 makes it possible to apply a higher voltage U2 to the spark gap SG than to the starting capacitor C1. For this purpose, the cathode of the diode is connected to the spark gap SG. In this case, according to the invention, the starting capacitor C1 is always charged to a predefined first voltage U1 in order to ensure a constant starting energy. A second voltage U2 which is high enough to allow the spark gap SG to break down, i.e. to be switched on, is applied to the spark gap SG. This can take place, for example, by means of an external voltage source (not shown here). By virtue of the diode D1, the two voltages can be decoupled from one another and can thus be set independently. A prerequisite for this is naturally that the minimum breakdown voltage of the spark gap is above the first voltage U1. The first voltage U1 at the starting capacitor C1 is set to a value which enables a predefined desired starting pulse energy. This voltage can either be set permanently or else can be set variably depending on the operating state. In general, there is a relationship between the starting pulse energy and the maximum voltage of the starting pulse, with the result that a starting pulse with a relatively high starting pulse energy with otherwise identical primary circuit parameters always results in a relatively high maximum voltage of the starting pulse. In order to conserve the insulation of the entire system, the starting pulse can thus be generated in such a way that it can always safely start the lamp depending on the operating state prevailing at that time, but at the same time is not unnecessarily high in order not to subject the insulation of the system to an excessive load.

In principle, a sufficiently high voltage can be applied to the spark gap in two ways: it is possible, as has already been described above, for a voltage source to be applied to the spark gap which is sufficiently high to enable said spark gap to break down. However, it is also possible for a charge to be applied to the capacitor C2, which is connected in parallel with the spark gap, by means of which charge the second voltage U2 is then generated at the capacitor and therefore also at the spark gap. The capacitance C2 can comprise the parasitic capacitance of the spark gap and of the components connected thereto, such as the diode D1, for example. The capacitance can also comprise this capacitance and the capacitance of a real capacitor connected in parallel with the spark gap. This is dependent on the real conditions and the configuration of the circuit arrangement according to the invention. Preferably, the capacitance C2 is markedly lower than the capacitance of the starting capacitor C1, preferably C2<0.3*C1. This means that the influence of the capacitance C2 on the starting energy remains negligibly low.

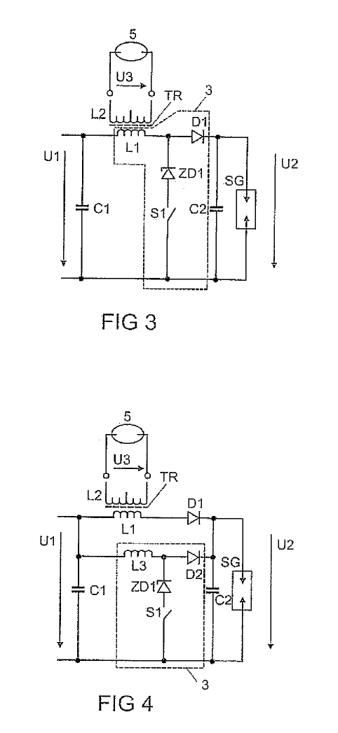

FIG. 3 shows a circuit arrangement according to the invention for starting a discharge lamp in a second embodiment with a diode D1 as decoupling element, which is part of an inductor-type step-up converter 3, which uses the primary winding of the starting transformer as inductor. With this circuit arrangement, a voltage source is no longer required in order to provide the second voltage U2. The inductor-step-up converter 3 functions as a charge pump for the capacitance C2 and, over a few cycles, generates a voltage across the capacitance C2 which is sufficient for striking the spark gap. As a result of the fact that the second voltage U2 is generated by means of a few cycles, the starting time of the gas discharge lamp 5 connected to the starting voltage U3 can be set very precisely. The zener diode ZD1 in this case serves the purpose of reducing the voltage at the second switch S1, which is in the form of a transistor. Since the efficiency of the inductor-type step-up converter 3 is insignificant in the few cycles before the breakdown of the spark gap, the zener diode ZD1 can be installed in series with the second switch or switching transistor S1. As a result, the switching transistor S1 needs to be designed for a lower off-state voltage. In this case, the losses in the zener diode ZD1 are insignificant. Since switching transistors with a low off-state voltage are markedly less expensive, this trick helps to keep the costs of the circuit arrangement according to the invention low. The zener voltage of the zener diode ZD1 needs to be selected to be lower than the steady-state value of the first voltage U1, i.e. the voltage U1 to which the starting capacitor C1 is ultimately charged. This is necessary since, otherwise, no current would flow through the switch/transistor S1 during operation thereof. Expressed in figures, the zener voltage U_{zener} of the zener diode ZD1 should be from 0.2 to 0.95 times the voltage U1 at the starting capacitor C1: U_{zener}=(0.2 . . . 0.95)*U1. The inductor-type step-up converter 3 uses the primary winding of a starting transformer TR as inductor. This requires precise matching of all of the components in order for the starting transformer and the inductor-type step-up converter to be able to fulfill their functions in optimum fashion. In some cases, however, the function as primary winding for the starting transformer TR and the function as inductor for the inductor-type step-up converter 3 cannot be combined for the winding L1 since the inductance values required for both applications for the winding L1 cannot be reconciled. In this case, a third embodiment of the circuit arrangement according to the invention is used.

FIG. 4 shows a circuit arrangement according to the invention for starting a discharge lamp in a third embodiment with a diode as decoupling element and an inductor-type step-up converter. In this case, the inductor-type step-up converter comprises an additional inductor L3, an additional diode D2 and the series circuit comprising a zener diode ZD1 and a switch S1 known from the second embodiment. The input of the inductor-type converter is in this case connected to the charging voltage of the starting capacitor C1. However, in certain applications it may be expedient to use another internal voltage source in order to supply the inductor-type converter 3. Although this embodiment requires more components than the second embodiment, it is also possible for gas discharge lamps which are more difficult to start to be safely started with at the same time more complex boundary conditions. This embodiment has the greatest degree of freedom in terms of design and therefore virtually any starting task which is just as complex can be performed by correspondingly matching the component values. The inductor-type step-up converter in this case functions again on the capacitance C2, which can be in the form of a parasitic capacitance or in the form of a parallel circuit comprising a parasitic capacitance and a real capacitor. By virtue of the switch or switching transistor S1 being switched on and off again briefly, the charge stored in the inductor L3 is transferred to the capacitance, which results in a significant voltage increase across the capacitance C2. This corresponds to the mode of operation of the second embodiment, but here the inductor L3 and the capacitance C2 can be matched to one another more effectively. The switch or switching transistor S1 can be switched on and off again a plurality of times in succession. In specific cases, however, it is also possible for the required second voltage U2 to be generated by the switch or switching transistor S1 being switched on and off again once.

The component values of a preferred configuration of the third embodiment are given in the table below:

| | |
|---|---|
| C1 | 68 nF |
| C2 | 0 . . . 5 nF |
| L1 | 1.3 μH |
| L2 | 700 μH |
| LD | Not provided |
| U1 | 200 V . . . 700 V |
| D1 | Diode with 600 V off-state voltage |
| D2 | Diode with 600 V off-state voltage |
| ZD1 | zener diode with 400 V zener voltage |
| L3 | 470 μH |
| SG | Spark gap with 800 V ± 20% breakdown voltage |

In this case, the voltage U1 can be varied from 200V to 700V depending on the desired starting energy. In this case, the starting energy can depend on the lamp state of the gas discharge lamp 5, for example it may be higher in the case of a hot lamp. At a voltage U1 of 500V the starting energy is, for example, 0.5*70 nF*(500V)²=8.75 mJ corresponding to a starting pulse level of 17 kV. At a voltage U1 of 700V, the starting energy is, for example, 0.5*70 nF*(700V)²=17.15 mJ, corresponding to a starting pulse level of 22 kV. The switch-on time of the switch/switching transistor S1 is in this case varied corresponding to the voltage U1 in such a way that the duration during which the switch/switching transistor is closed decreases at a higher voltage U1 in order to reduce the voltage and current loading on the switch/switching transistor S1. The switch-on duration of the switch/switching transistor S1 is accordingly 2.5 μs at a first voltage U1 of 500V and 0.2 μs at a first voltage U1 of 700V.

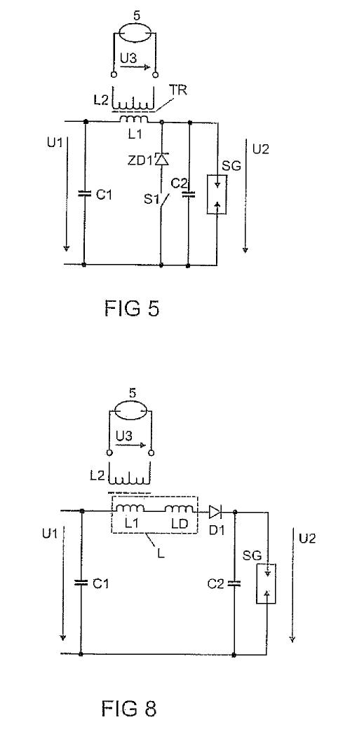

FIG. 5 shows a circuit arrangement according to the invention for starting a discharge lamp in a fourth embodiment with the primary winding of the starting transformer as decoupling element and a spark gap for increasing the second voltage. This represents a slightly simplified embodiment of the second embodiment. In this case, the primary winding of the starting transformer TR is used as decoupling element, which means that all of the operations required for starting need to take place very quickly since the primary winding of the starting transformer TR, as the inductive component, is transmissive for DC voltage and AC voltage of a low frequency. Ideally, in this case, the voltage across the capacitance C2 is generated by only one switching operation of the second switch S1. By virtue of S2 being switched on briefly, a resonant overvoltage is produced at the threshold value switch S1. As a result, the voltage U2 is substantially higher than the voltage U1 for a short period of time. The resonant voltage overshoot is applied to the threshold value switch for only a short period of time. This results in the threshold value switch or the spark gap SG needing to switch very rapidly in order to be able to utilize this effect. If the spark gap SG switches too slowly, the voltages U1 and U2 will have already become equal again and the starting mechanism will not work. In order to improve the response of the threshold value switch, it is advantageous to extend the time duration of the resonant voltage overshoot. This can be achieved by virtue of increasing the effective primary inductance and by increasing the capacitance C2. For this purpose, an additional inductance can be connected in series with a primary winding and/or an additional capacitance can be connected in parallel with a threshold value switch. The additional inductance can in this case be designed such that it enters saturation once SG has switched on during discharge of C1. This has the advantage that, during breakdown of SG there is only a small voltage drop across the additional inductance and therefore the starting pulse level is only reduced slightly.

The component values of a preferred configuration of the fourth embodiment will be given in the table below:

| | |
|---|---|
| C1 | 68 nF |
| C2 | 0.5 . . . 5 nF |
| L1 | 1.3 μH |
| LD | 1 . . . 5 μH |
| L2 | 700 μH |
| U1 | 500 . . . 600 V |
| ZD1 | zener diode with 400 V zener voltage |
| SG | Spark gap with 800 V ± 20% breakdown voltage |

This switching mechanism with a very fast-response threshold value switch or a fast-response spark gap SG can naturally also be applied in accordance with the invention to a circuit arrangement known per se, as in FIG. 1. If in this case a voltage is applied to the spark gap SG from an external voltage source (not shown here) and the spark gap SG switches quickly, the voltage U1 applied to the starting capacitor C1 can be decoupled from the voltage U2 triggering the threshold value switch or the spark gap SG by means of L1 without the additional components being required. This represents the simplest embodiment for a starting method according to the invention and only requires one first threshold value switch with a fast response and one voltage source, which is capable of applying the voltage to the threshold value switch with a high rate of change in voltage.

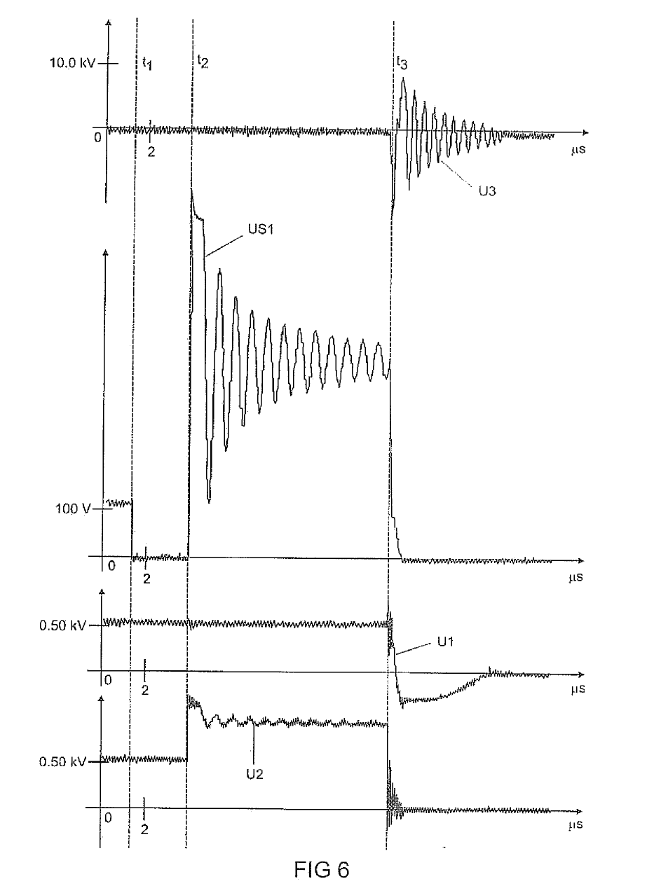

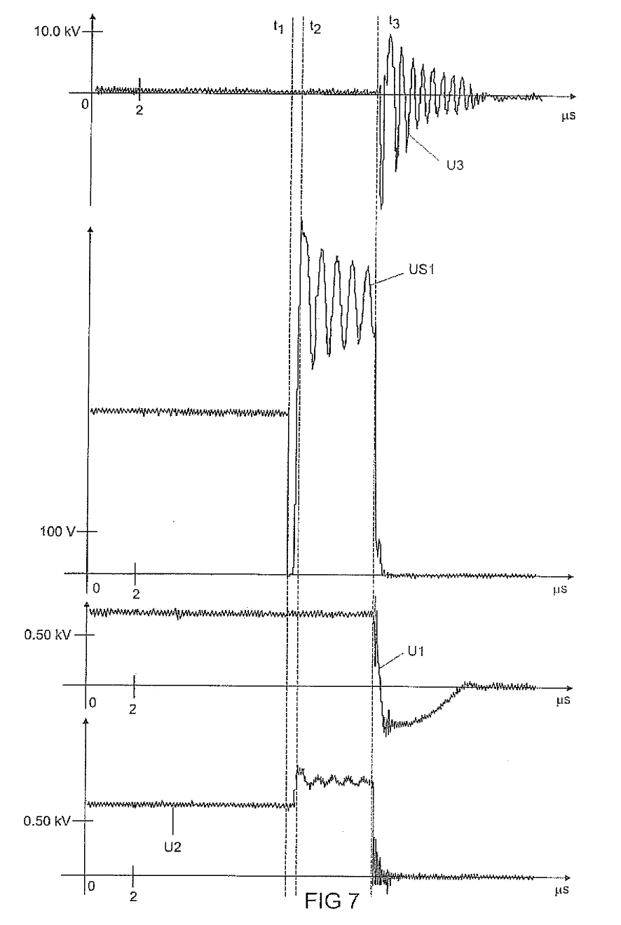

FIGS. 6 and 7 show some relevant signals which illustrate the mode of operation of the circuit arrangement according to the invention at a charging voltage of the starting capacitor of 500V and 700V, respectively. The voltages U1, U2, U3 and the voltage across the second switch or switching transistor S1 are in this case plotted over a time axis of 2 μs/DIV. The basis for these signals is a circuit arrangement according to the invention in the third embodiment. At time t₁, the second switch S1 or the transistor of the inductor-type converter switches on, which can easily be seen from the voltage US1, which breaks down to zero. At time t₂, the second switch S1 or the transistor of the inductor-type converter switches off again, whereupon an oscillation is brought about which is also reflected in the spark gap voltage U2. This voltage increases suddenly by a defined value up until the switch-off time. In this example, the configuration is selected such that the voltage for the break down of the SG is reached with only one switching operation. In principle, however, this can also only be the case after several switching operations. It can clearly be seen that the voltage U1 at the starting capacitor is independent of the voltage U2 at the spark gap. At time t₃, the spark gap breaks down, and the voltage U1 is discharged into a circuit current in the primary circuit, which generates a high starting voltage profile of the starting voltage U3 on the secondary side of the starting transformer TR. If both FIGS. 6 and 7 are compared, the relationship between the voltage U1 and the starting capacitor C1 and the starting voltage U3 can easily be identified. In FIG. 6, the starting capacitor C1 is charged to a voltage of 500V, and the resultant maximum starting voltage is approximately 17 kV. In FIG. 7, the starting capacitor is charged to a voltage of 700V, and the maximum starting voltage is approximately 22 kV. The figures also clearly show the relationship mentioned at the outset between the switch-on time of the second switch S1 and the voltage U1 at the starting capacitor C1. If the starting capacitor C1 has been charged to 500V (FIG. 6), the second switch S1 is switched on for approximately 2.5 μs. This corresponds to the time span between times t₁ and t₂. If the starting capacitor C1 has been charged to 700V (FIG. 7), the second switch S1 is now only switched on for approximately 200 ns.

FIG. 8 shows a circuit arrangement according to the invention for starting a discharge lamp in a fifth embodiment with a diode D1 as decoupling element and a spark gap SG as first switch, which is similar to the first embodiment. This embodiment shows by way of example that the inductance in the starting circuit needs to comprise not only the primary inductance L1 of the starting transformer but an inductor LD can also be connected in series therewith, said inductor LD and primary inductance L1 together forming the inductance L. These circuit variants can naturally also be used in all other embodiments. This measure makes it possible to be able to match the inductance value of L better to the requirements of the circuit. This can be advantageous primarily in the second embodiment and the fourth embodiment since, in this case, precise matching of the components, primarily of the inductance value of the step-up converter, generally results in an increase in the converter efficiency. This makes it possible to significantly increase the converter efficiency and therefore the power of the overall circuit arrangement in unfavorable cases with a single inexpensive component.

We claim:

1. A circuit arrangement for starting a discharge lamp, with a primary circuit, which comprises a series circuit comprising an inductance, a starting capacitor and a first switch, the switch being in the form of a threshold value switch, and the inductance comprising the primary winding of the starting transformer, and the primary circuit being designed to generate a starting pulse for the discharge lamp at the secondary winding of a starting transformer, wherein the primary circuit has two decoupled voltages, a first voltage, which is correlated substantially with the energy of the starting pulse, and a second voltage, which controls the operating time of the first switch, the first voltage being lower than the threshold value of the first switch.

2. The circuit arrangement as claimed in claim 1, wherein the inductance or the inductance in series with a diode is arranged between the first voltage and the second voltage, the cathode of the diode being connected to the first switch.

3. The circuit arrangement as claimed in claim 1, wherein the inductance comprises a series circuit comprising the primary winding of the starting transformer with an additional inductor.

4. The circuit arrangement as claimed in claim 3, wherein the additional inductor becomes saturated during discharge of the starting capacitor at the starting instant.

5. The circuit arrangement as claimed in claim 1, wherein the first switch is a spark gap or a SIDAC or a component with an operative equivalent threshold value characteristic.

6. The circuit arrangement as claimed in claim 1, wherein a capacitance is connected in parallel with the threshold value of the first switch.

7. The circuit arrangement as claimed in claim 1, comprising a controllable voltage source or a controllable current source or a DC/DC voltage converter or charge pump for charging the parallel capacitance.

8. The circuit arrangement as claimed in claim 7, wherein the DC/DC voltage converter is an inductor-type step-up converter with a second switch.

9. The circuit arrangement as claimed in claim 8, wherein a zener diode is arranged in series with the second switch, the anode of the zener diode being connected to the switch.

10. A method for starting a discharge lamp, with a primary circuit which comprises a series circuit comprising an inductance, a starting capacitor and a first switch, the switch being in the form of a threshold value switch and the inductance comprising the primary winding of the starting transformer, and the primary circuit being designed to generate a starting pulse for the discharge lamp at the secondary winding of a starting transformer, wherein the method comprises the steps of:
charging the starting capacitor to a first voltage; and
applying a second voltage to the first switch in order to switch on said switch.
